(19) United States
(12) Patent Application Publication
(10) Pub. No.: US 2023/0161754 A1
(43) Pub. Date: May 25, 2023

(54) DATA PROCESSING METHOD AND APPARATUS, ELECTRONIC DEVICE, AND STORAGE MEDIUM

(71) Applicant: Alibaba Cloud Computing Ltd., Hangzhou (CN)

(72) Inventors: Chao GUO, Hangzhou (CN); Feifei Li, Hangzhou (CN)

(21) Appl. No.: 18/095,522

(22) Filed: Jan. 10, 2023

Related U.S. Application Data
(63) Continuation of application No. PCT/CN2021/105201, filed on Jul. 8, 2021.

(30) Foreign Application Priority Data
Jul. 10, 2020 (CN) 202010664421.X

(51) Int. Cl. G06F 16/23; G06F 16/27; G06F 16/215

(52) U.S. Cl. CPC G06F 16/2365; G06F 16/278; G06F 16/215

(57) ABSTRACT

A data processing method and apparatus, and an electronic device, and a storage medium. The method comprises: determining a master data range on the current node (S102), master data within the master data range corresponds to multiple pieces of copy data stored on other nodes; segmenting the master data range into multiple first sub-data ranges (S104); and performing data recovery on each of the first sub-data ranges, so as to repair inconsistent data between sub-data in the first sub-data ranges and corresponding copy sub-data in the copy data to make them consistent. The technical solutions of the present disclosure overcome the defect of resource waste caused by performing repeated repair on data with multiple copies stored on multiple nodes during a data repair process.

### CROSS REFERENCE TO RELATED APPLICATIONS

This application claims priority to and is a continuation of PCT Patent Application No. PCT/CN2021/105201, filed on 8 Jul. 2021 and entitled “DATA PROCESSING METHOD AND APPARATUS, AND ELECTRONIC DEVICE, AND STORAGE MEDIUM,” which claims priority to Chinese Patent Application No. 202010664421.X, filed on 10 Jul. 2020 and entitled “DATA PROCESSING METHOD AND APPARATUS, ELECTRONIC DEVICE, AND STORAGE MEDIUM,” which are incorporated herein by reference in their entirety.

### TECHNICAL FIELD

The present disclosure relates to the field of computer technology, and, more particularly, to data processing methods and apparatuses, electronic devices, and storage media.

### BACKGROUND

In order to ensure data reliability in a distributed system, a piece of data is usually stored on multiple nodes, and the data on the multiple nodes need to be kept consistent. However, some distributed systems may have inconsistent data copies due to various reasons. For example, when users in a Cassandra database use one, two, quorum, and other different levels to write data to multiple data copies, some of the copies may be incomplete. Common distributed systems also have their own data repair functions, such as the hint & read-repair mechanism of the Cassandra database, but this repair mechanism may cause a large system resource overhead and high operation and maintenance costs.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Embodiments of the present disclosure provide data processing methods and apparatuses, electronic devices, and computer-readable storage media.

An embodiment of the present disclosure provides a data processing method, comprising:

determining a master data range on a current node, wherein master data in the master data range corresponds to multiple copy data stored on other nodes;

segmenting the master data range into multiple first sub-data ranges; and

performing data repair on each of the first sub-data ranges respectively, so as to repair inconsistent data between sub-data in the first sub-data ranges and corresponding copy sub-data in the copy data to make them consistent.

Further, the performing data repair on each of the first sub-data ranges respectively, so as to repair inconsistent data between sub-data in the first sub-data ranges and corresponding copy sub-data in the copy data to make them consistent comprises:

generating first data repair tasks corresponding to each of the first sub-data ranges, wherein the repair tasks are used for repairing the inconsistent data between the sub-data in the first sub-data ranges and the corresponding copy sub-data in the copy data to make them consistent; and

assigning priorities to the first data repair tasks and then submitting them to a task queue, so that the first data repair tasks are executed from the task queue according to the priorities.

Further, the method also comprises:

assigning a repair identifier to repaired data in the first sub-data ranges; and

identifying the first sub-data ranges as being in a repair-completed state after all data in the first sub-data ranges are assigned the repair identifier.

Further, the method also comprises:

determining a second sub-data range based on a first piece of data that starts to fail in the repair to a first piece of data that starts to succeed in the repair;

generating a second data repair task corresponding to the second sub-data range; and

assigning a priority to the second data repair task and then submitting it to the task queue.

Further, the method also comprises:

after the current node is recovered from a downtime, regenerating the first data repair tasks for the first sub-data ranges in a repair-uncompleted state, and submitting the regenerated first data repair tasks to the task queue.

Further, the performing data repair on each of the first sub-data ranges respectively, so as to repair inconsistent data between sub-data in the first sub-data ranges and corresponding copy sub-data in the copy data to make them consistent comprises:

determining whether the current first sub-data range belongs to the master data range on the current node; and

in response to determining that the current first sub-data range belongs to the master data range on the current node, performing the data repair on the current first sub-data range.

Further, the method also comprises:

after all the first sub-data ranges on the current node are in the repair-completed state, starting a next round of the data repair process.

Further, the method also comprises:

after each round of the data repair process starts, determining a repair period of the current node according to a data size of the master data range and a preset expiration time of deleted data; and

determining a data repair speed according to the repair period, so as to complete a round of repair of all data in the master data range according to the data repair speed within the preset expiration time.

An embodiment of the present invention provides a data storage system, comprising:

multiple nodes which comprise one or more storage devices and one or more processing devices, wherein

the storage device is configured to store master data and/or copy data, and the master data and the copy data corresponding to the same data are stored on the storage devices of different nodes; and

the processing device is configured to repair data on the storage device and during the data repair process, the processing device segments a master data range where the master data on the storage device is located into multiple first sub-data ranges, and performs the data repair on each of the first sub-data ranges respectively, so as to repair inconsistent data between sub-data in the first sub-data ranges and corresponding copy sub-data in the copy data to make them consistent.

Further, when performing the data repair on each of the first sub-data ranges, the processing device generates first data repair tasks corresponding to each of the first sub-data ranges;

the processing device also assigns priorities to the first data repair tasks and then submits them to a task queue; and

the processing device further executes the first data repair tasks from the task queue according to the priority, so that the repair tasks repair the inconsistent data between the sub-data in the first sub-data ranges and the corresponding copy sub-data in the copy data to make them consistent.

Further, the processing device assigns a repair identifier to repaired data in the first sub-data ranges, and identifies the first sub-data ranges as being in a repair-completed state after all data in the first sub-data ranges are assigned the repair identifier.

Further, during the data repair process, the processing device determines a second sub-data range based on a first piece of data that starts to fail in the repair to a first piece of data that starts to succeed in the repair, generates a second data repair task corresponding to the second sub-data range, and assigns a priority to the second data repair task and then submits it to the task queue.

Further, after the node where the processing device is located is recovered from a downtime, the processing device regenerates the first data repair tasks for the first sub-data ranges in a repair-uncompleted state and submits the regenerated first data repair tasks to the task queue.

Further, when starting to perform the data repair on the first sub-data ranges, the processing device determines whether the current first sub-data range belongs to the master data range on a current node and when the current first sub-data range belongs to the master data range on the current node, performs the data repair on the current first sub-data range.

Further, after all the first sub-data ranges on the storage device are in the repair-completed state, the processing device starts a next round of the data repair process.

Further, after each round of the data repair process starts, the processing device determines a repair period according to a data size of the master data range and a preset expiration time of deleted data, and also determines a data repair speed according to the repair period; and the processing device completes a round of repair of all data in the master data range according to the data repair speed within the preset expiration time.

Further, the processing device acquires the sub-data in the first sub-data ranges from the storage device and acquires the copy sub-data corresponding to the sub-data in the first sub-data ranges from nodes where the copy data are located; and

the processing device performs a pairwise comparison between the sub-data and the copy sub-data and repairs the inconsistent data based on a result of the comparison.

An embodiment of the present invention provides a data processing apparatus, comprising:

a first determination module, configured to determine a master data range on a current node, wherein master data in the master data range corresponds to multiple copy data stored on other nodes;

a segmentation module, configured to segment the master data range into multiple first sub-data ranges; and

a repair module, configured to perform data repair on each of the first sub-data ranges respectively, so as to repair inconsistent data between sub-data in the first sub-data ranges and corresponding copy sub-data in the copy data to make them consistent.

The above-described functions may be implemented by hardware, or hardware executing corresponding software. The hardware or software comprises one or more modules corresponding to the above-described functions.

In an example design, the structure of the above-described apparatus comprises a memory and a processor, wherein the memory is configured to store one or more computer instructions that support the above-described apparatus to execute the above-described corresponding method, and the processor is configured to execute the computer instructions stored on the memory. The above-described apparatus may further comprise a communication interface for the above-described apparatus to communicate with other devices or a communication network.

An embodiment of the present disclosure provides an electronic device, comprising a memory and a processor, wherein the memory is configured to store one or more computer instructions, and the one or more computer instructions are executed by the processor to implement the method according to any one of the above-described aspects.

An embodiment of the present disclosure provides a computer-readable storage medium configured to store computer instructions used by any one of the above-described apparatuses, comprising relevant computer instructions for executing the method described in any one of the above-described aspects.

The technical solutions provided by the embodiments of the present disclosure may have at least the following beneficial effects:

during the repair process of a distributed system according to the embodiments of the present disclosure, each node automatically inquires and repairs data in a master data range stored thereon and, after segmenting the master data range into first sub-data ranges with finer granularity, performs data repair on the first sub-data ranges. In this way, the present techniques not only overcome the defect of resource waste caused by performing repeated repair on data with multiple copies stored on multiple nodes during the data repair process in the conventional techniques but also can realize breakpoint resume by segmenting the master data range into first sub-data ranges with finer granularity and enable data repair on a node to be controlled in a long time frame by controlling the execution progress of a single repair, avoiding an instantaneous increase in resource consumption.

It should be understood that the foregoing general description and the following detailed description are for exemplary and explanatory purposes only, and are not intended to limit the present disclosure.

### BRIEF DESCRIPTION OF DRAWINGS

The features, objectives, and advantages of the present disclosure will become more apparent from the following detailed description of non-limiting implementation manners in conjunction with the accompanying drawings.

FIG. 1 is a flowchart of a data processing method according to an implementation manner of the present disclosure;

FIG. 2 is a schematic diagram of a data repair process of first sub-data ranges according to an implementation manner of the present disclosure;

FIG. 3 is a structural block diagram of a data storage system according to an implementation manner of the present disclosure;

FIG. 4 is a schematic diagram of a data consistency repair architecture in a data storage system according to an implementation manner of the present disclosure;

FIG. 5 is a structural block diagram of a data processing apparatus according to an implementation manner of the present disclosure; and

FIG. 6 is a schematic structural diagram of an electronic device suitable for implementing a data processing method according to an implementation manner of the present disclosure.

### DESCRIPTION OF EMBODIMENTS

Hereinafter, exemplary implementation manners of the present disclosure will be described in detail with reference to the accompanying drawings so that those skilled in the art can easily implement them. Also, for the sake of clarity, parts unrelated to describing the exemplary implementation manners are omitted from the drawings.

In the present disclosure, it should be understood that terms such as “comprising” or “having” are intended to indicate the existence of features, numbers, steps, actions, components, parts, or combinations thereof disclosed in this specification, and are not intended to exclude the possibility that one or more of other features, numbers, steps, actions, components, parts, or combinations thereof may exist or be added.

In addition, it should be noted that the embodiments of the present disclosure and the features of the embodiments may be combined with each other under the condition of no conflict. The present disclosure will be described in detail below with reference to the accompanying drawings and in conjunction with embodiments.

The details of the embodiments of the present disclosure will be described in detail below through specific embodiments.

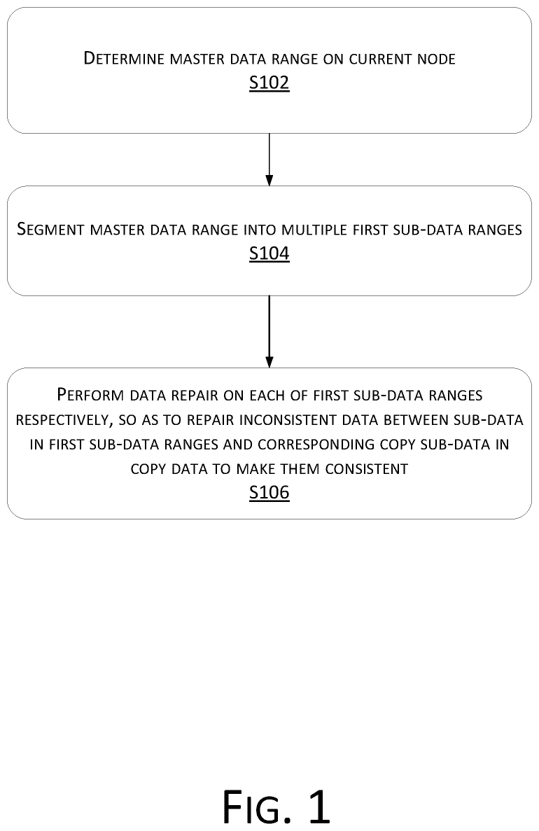

FIG. 1 is a flowchart of a data processing method according to an implementation manner of the present disclosure. As shown in FIG. 1, the data processing method comprises the following steps:

Step S102: determine a master data range on a current node, wherein master data in the master data range corresponds to multiple copy data stored on other nodes;

Step S104: segment the master data range into multiple first sub-data ranges; and

Step S106: perform data repair on each of the first sub-data ranges respectively, so as to repair inconsistent data between sub-data in the first sub-data ranges and corresponding copy sub-data in the copy data to make them consistent.

For example, the Datastax cluster system uses the Cassandra database to store data, and each node in the cluster system will repair all the stored data (including master data and copy data) at an appropriate time. Before each round of repair, the repaired data will be segmented into many small data segments, and after the segmentation is completed, data in the data segments will be repaired according to a self-defined strategy. The repair process is mainly to reuse Cassandra's read-repair logic. Each piece of data in the data segments will trigger a read operation, and if the read data are found to be abnormal (for example, inconsistent with corresponding data on other nodes), they will be repaired asynchronously. In the whole process, each node will repair data in all the ranges that the node is responsible for, including the master data in the master data range and the copy data in the copy data ranges stored as copies, so if a data sheet in a cluster is stored on three nodes, each of the three nodes will repair the data sheet, three times in total. Therefore, the above data repair solution adopted in the Datastax cluster system will cause repeated calculations, IO operations, etc., which will eventually reduce the repair speed.

For example, the data repair solution adopted in the Scylladb system will set up a buffer pool of the same size both on a master node and on a corresponding copy node, and each time the master node and the copy node will start to read data from the smallest data in the range and fill the buffer pools with the read data, then calculate the hash values corresponding to the two buffer pools, and compare the two hash values to determine a data range to be repaired in the first step. If the harsh values are different, the to-be-repaired data range will be determined from the data that fill the buffer pools according to the minimum set, and then the master data and the copy data are repaired in batches; however, this solution requires multiple hash calculations (including calculation required when determining the data range and calculation required when repairing the data) and consumes many resources; in addition, the granularity of each comparison of this solution is the size of the buffer pools. If only one piece of data in the buffer pools is different, the data of the entire buffer pool size will still be calculated eventually, causing a lot of redundant calculations.

In this embodiment, a data cluster comprises multiple nodes, each of the nodes stores data in a distributed system, and the same block of data in the distributed system may include multiple copies, which are respectively stored on the multiple nodes, for example, on 3 nodes, and one of the nodes stores master data of the block of data, and the other nodes store copy data of the block of data. In order to ensure that the data in the distributed system are not lost, it is necessary to ensure consistency between the master data and the copy data. In order to ensure consistency between the master data and the copy data, in this embodiment of the present disclosure, each of the nodes automatically repairs the master data it is responsible for (if the node also stores copy data of other nodes, the copy data will be repaired by the other nodes rather than the node). It should be noted that multiple different blocks of data can be stored on the same node, and the multiple different blocks of data can be master data or copy data, that is to say, both master data and copy data can be stored on the same node.

Therefore, in the data repair process according to this embodiment of the present disclosure, each of the nodes repairs the master data stored on the node, and the copy data stored on the node are repaired by the node storing the master data corresponding to the copy data. In this way, it can avoid the problem that multiple nodes repeatedly repair the same block of data, thereby saving system resources.

In this embodiment, after a round of repair starts, each of the nodes determines the master data range stored on the current node, that is, the range of the master data stored on the current node, for example, the range from the first record to the last record of the master data. Of course, it can be understood that when the master data of multiple blocks of data are stored on the current node, there may be multiple master data ranges. It should be noted that the master data in the master data range has multiple copy data stored on other nodes. The purpose of data repair is to repair the master data in the master data range and the multiple copy data stored on other nodes, so as to keep consistency between the master data and the copy data.

After the current node determines the master data range, the master data range can be segmented into multiple first sub-data ranges, and the size of the sub-data in the first sub-data ranges can be predefined, for example, the size of the sub-data in the first sub-data ranges is 200M by default. Of course, it can be modified to other sizes in advance if necessary, depending on the actual situation, which is not limited herein. For example, in the segmentation process, the segmentation may start from the smallest data record in the master data range, and every N pieces of data are segmented into a first sub-data range. When there are multiple blocks of master data on the current node, the above-described method is used for segmenting each block of master data.

After multiple first sub-data ranges are obtained by segmentation, data repair may be performed on each of the first sub-data ranges. During the repair process of the first sub-data ranges, for example, starting from the first one of the first sub-data ranges, the data in the current first sub-data range in the master data and the data corresponding to the current sub-data range in the copy data stored on other nodes are read and compared. If they are inconsistent, it can be determined whether the data in the current first sub-data range in the master data are incorrect or the data in the current first sub-data range in the copy data are incorrect. For example, if the current node stores the master data and the other two nodes store the copy data respectively, three pieces of data in the current first sub-data range can be read from the current node and the other two nodes, and by a pairwise comparison of consistency, it can be determined which node has wrong data and repair the wrong data. In some embodiments, during the comparison of data consistency, one key record may be used as the granularity for comparison, and this repair method will not cause a situation in which batches of data are mis-repaired when only individual keys are different.

After the data in all the first sub-data ranges on the current node are repaired, the current node can start a next round of polling and repair and repeat the above-described repair process. In this embodiment of the present disclosure, when a round of repair starts, the time required for the round of repair can be calculated through flow control and according to the data size in the master data range on the current node, and the flow control speed can be controlled to ensure that the round of repair is completed in a preset time frame. The preset time frame is related to a storage policy of a distributed file system. For example, when Cassandra deletes a piece of data, it will perform an insert operation. The newly inserted piece of data is called a tombstone. The biggest difference between a tombstone and a normal record is that the tombstone has an expiration time. When the expiration time is reached, the tombstone data will be actually deleted from the disk when Cassandra performs a compaction operation; therefore, in this embodiment of the present disclosure, when Cassandra is used for storing data, the preset time frame can be set to be the tombstone's expiration time (10 days by default).

During the repair process of a distributed system according to the embodiments of the present disclosure, each node automatically polls and repairs data in a master data range stored thereon and, after segmenting the master data range into first sub-data ranges with finer granularity, performs data repair on the first sub-data ranges. In this way, it not only overcomes the defect of resource waste caused by performing repeated repair on data with multiple copies stored on multiple nodes during the data repair process in the conventional techniques but also can realize breakpoint resume by segmenting the master data range into first sub-data ranges with finer granularity and enable data repair on a node to be controlled in a long time frame by controlling the execution progress of a single repair, avoiding an instantaneous increase in resource consumption.

In an example implementation manner of this embodiment, the Step S106, namely the step of performing data repair on each of the first sub-data ranges respectively, so as to repair inconsistent data between sub-data in the first sub-data ranges and corresponding copy sub-data in the copy data to make them consistent further comprises the following steps:

generating first data repair tasks corresponding to each of the first sub-data ranges, wherein the repair tasks are used for repairing the inconsistent data between the sub-data in the first sub-data ranges and the corresponding copy sub-data in the copy data to make them consistent; and

assigning priorities to the first data repair tasks and then submitting them to a task queue, so that the first data repair tasks are executed from the task queue according to the priorities.

In this example implementation manner, a first data repair task may be started for each of the first sub-data ranges, a priority may also be set for each of the first sub-data ranges according to a preset factor, and the first data repair tasks may be invoked and executed according to the set priority, for example, the first data repair task with a higher priority may be invoked and executed first. In some embodiments, the priority assigned to a first data repair task corresponding to a first sub-data range may indicate the urgency of data repair of the first sub-data range, and the first sub-data ranges requiring urgent repair may be assigned a higher priority, while those that do not require urgent repair may be assigned a lower priority. For example, a first sub-data range at the front of the master data range may be assigned a higher priority, while a first sub-data range at the rear may be assigned a lower priority. In this way, more urgent first sub-data ranges can be repaired before the other first sub-data ranges according to the degree of urgency.

In an example implementation manner of this embodiment, the method further comprises the following steps:

assigning a repair identifier to repaired data in the first sub-data ranges; and

identifying the first sub-data ranges as being in a repair-completed state after all data in the first sub-data ranges are assigned the repair identifier.

In this example implementation manner, the first data repair tasks may perform comparative repair at a fine granularity on the data in the first sub-data ranges, for example, when one key record is used as the granularity for comparative repair of the data, the repair can be performed by comparing whether the data record corresponding to the current key in the first sub-data ranges is consistent with the record corresponding to the key in the copy data. When the data corresponding to the current key are consistent with the corresponding data in the copy data, the data corresponding to the key can be assigned the repair identifier, indicating that the data have been repaired, and when the data corresponding to the current key are inconsistent with the corresponding data in the copy data, the inconsistent data between the current key and the copy data can be repaired, and after the repair is completed, the data corresponding to the current key are assigned the repair identifier. In this way, after all the data in the first sub-data ranges are assigned the repair identifier, it can be determined that the data in the first sub-data ranges have been repaired, so the first sub-data ranges can be identified as being in a repair-completed state, otherwise the data in the first sub-data ranges can be identified as being in a repair-uncompleted state.

In an example implementation manner of this embodiment, the method further comprises the following steps:

with respect to the corresponding data in the copy data, determining a second sub-data range based on a first piece of data that starts to fail in the repair to a first piece of data that starts to succeed in the repair;

generating a second data repair task corresponding to the second sub-data range; and

assigning a priority to the second data repair task and then submitting it to the task queue.

In this example implementation manner, during the data repair process, if the node where the copy data are located goes down, the data will fail to be repaired starting from the downtime of the node where the copy data are located, and then repeated repair may be performed on each piece of data, such as 3 rounds of repair. If all the rounds of repair fail, the piece of data is recorded as failing in the repair and subsequent data are continued to be repaired; and after the node where the copy data are located is recovered, the subsequent data can be repaired successfully, so a second sub-data range can be determined from a first piece of data that starts to fail in the repair to a first piece of data that starts to succeed in the repair, and all the data in the second sub-data range fail to be repaired due to the downtime of the node where the copy data are located. Therefore, a second data repair task can be generated for the data in the second sub-data range, and the second data repair task can be assigned a priority and then submitted to the task queue, so that the second data repair task can be invoked from the task queue to re-repair the data in the second sub-data range. The second sub-data range is a sub-data range included in the first sub-data ranges. After the second data repair task corresponding to the second sub-data range is completed and all the data in the second sub-data range is successfully repaired, the first sub-data ranges are considered to be in a repair-completed state.

In an example implementation manner of this embodiment, the method further comprises the following steps:

after the current node is recovered from a downtime, regenerating the first data repair tasks for the first sub-data ranges in a repair-uncompleted state, and submitting the regenerated first data repair tasks to the task queue.

In this example implementation manner, after the current node storing the master data goes down and gets recovered, the first sub-data ranges currently in the repair-completed state and the first sub-data ranges currently in the repair-uncompleted state can be obtained by querying the information recorded by the system. For the first sub-data ranges currently in the repair-uncompleted state, corresponding first data repair tasks can be regenerated, and the regenerated first data repair tasks can be assigned a priority and then submitted to the task queue to continue the repair of the data in the first sub-data ranges. In this implementation manner, the function of breakpoint resume can be realized, and the granularity of breakpoint resume is one sub-data range. In some embodiments, the size of one sub-data range may be set as 200M, so the granularity of breakpoint resume in this way is relatively fine, and the data repair efficiency can be improved.

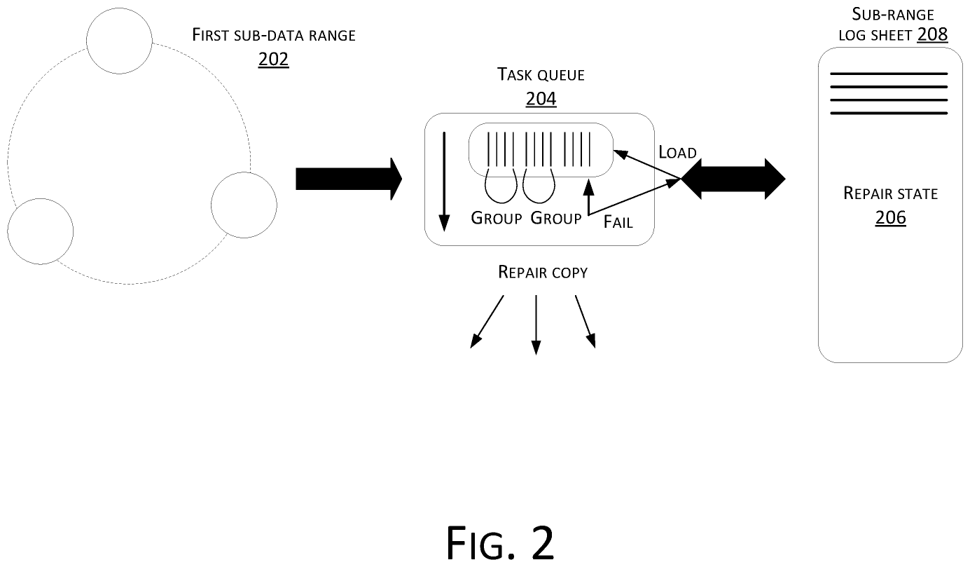

FIG. 2 is a schematic diagram of a data repair process of first sub-data ranges according to an implementation manner of the present disclosure. As shown in FIG. 2, after a first data repair task corresponding to each of the first sub-data ranges 202 is started, the repair task is submitted to the task queue 204 and then invoked by the execution engine according to the priority, and the repair state 206 of a current sub-data range is obtained from the sub-range log sheet 208 of the system at each time of invoking. If it is in a repair-completed state, the repair task may not be executed, and if it is in a repair-uncompleted state, the sub-data and the copy sub-data corresponding to the first sub-data range are started to be repaired. If the repair is successful, the repair state 206 in the sub-range log sheet is identified as being in the repair-completed state, and if the repair fails, the repair state 206 in the sub-range log sheet 208 is identified as being in the repair-uncompleted state, and meanwhile, a new repair task is started and submitted to the task queue 204 for continued execution next time.

In an example implementation manner of this embodiment, the Step S106, namely the step of performing data repair on each of the first sub-data ranges respectively, so as to repair inconsistent data between sub-data in the first sub-data ranges and corresponding copy sub-data in the copy data to make them consistent further comprises the following steps:

determining whether the current first sub-data range belongs to the master data range on the current node; and

when the current first sub-data range belongs to the master data range on the current node, performing the data repair on the current first sub-data range.

In this example implementation manner, before repairing the data in each of the first sub-data ranges, it may be determined whether the current first sub-data range still belongs to the master data range on the current node. This is because, after a new node is added to the cluster, there may be a situation that the master data range to be repaired by a node in the original cluster overlaps with the master data range to be repaired by the new node, for example, the master data range that the node A is originally responsible for is 1-5, and the newly added node B shares the master data range of 3-5. Since the node A will still repair the master data range of 1-5 during this round of repair, while the node B will repair the master data range of 3-5 once it is added and its state is changed to normal, there may be a situation that the data range of 3-5 is subjected to overlapped repair. This will not affect the correctness, but will cause repeated data repair. In order to solve this problem, the embodiment of the present disclosure uses one first sub-data range as the granularity, and when starting a data repair process of a new first sub-data range in each round, it only needs to first determine whether the first sub-data range still belongs to the master data range of the current node. In this way, the problem of resource waste caused by repeated data repair after a new node is added is solved.

In an example implementation manner of this embodiment, the method further comprises the following steps:

after all the first sub-data ranges on the current node are in the repair-completed state, starting a next round of the data repair process.

In this example implementation manner, the data repair process of each node may be a cyclic process, and a next round of the data repair process is started after one round of the data repair process ends. The element indicating the end of each round of the data repair process is that all the sub-data ranges in the master data range on the current node are in the repair-completed state. In this way, each node in the cluster can automatically poll and repair the master data in the master data range stored thereon and the copy data stored on other nodes corresponding to the master data in the master data range on other nodes, and eventually, all data on all nodes in the cluster can be continuously repaired so as to always keep consistency between the master data and the copy data in the cluster.

In an example implementation manner of this embodiment, the method further comprises the following steps:

after each round of the data repair process starts, determining a repair period of the current node according to a data size of the master data range and a preset expiration time of deleted data; and determining a data repair speed according to the repair period, so as to complete a round of repair of all data in the master data range according to the data repair speed within the preset expiration time.

In this example implementation manner, the preset expiration time of deleted data is the time that the deleted data are retained in a distributed system, which may vary with an adopted distributed system, for example, the preset expiration time in the Cassandra system may be gc_grace_seconds. When the Cassandra system deletes a piece of data, it will perform an insert operation. The newly inserted piece of data is called a tombstone. The biggest difference between a tombstone and a normal record is that the tombstone has an expiration time gc_grace_seconds. When the expiration time is reached, the tombstone data will be completely deleted. Therefore, the time that the data deleted at the application level are retained before they are completely deleted by the system is the preset expiration time of the deleted data. If a round of data repair is completed before the preset expiration time is reached, it will not eventually cause inconsistency between the master data and the copy data.

In this embodiment of the present disclosure, a data repair speed is determined according to the data size in the master data range and the preset expiration time, so that the data in the master data range on the current node are repaired according to the data repair speed to control the time for completing a round of repair process within the preset expiration time. In some embodiments, the data repair speed may be a flow control speed. The data size repaired every day can be controlled through the flow control speed. After the data size repaired every day is reached, the current repair process can be paused and then continued the next day. For example, if the data size in the master data range on a single node is N megabytes, and the preset expiration time is M days, the data size that can be repaired per day is N/M megabytes. The flow control speed can be deemed as N/M megabytes/day. In this way, the embodiment of the present disclosure balances a huge amount of repair tasks (for example, comparison of hash calculations, filling of data gaps between the master data and the copy data, etc.), and performs repair in the allowable time frame of the distributed system, reducing the impact of data repair on customers.

In an example implementation manner of this embodiment, the Step S106, namely the step of performing data repair on each of the first sub-data ranges respectively, so as to repair inconsistent data between sub-data in the first sub-data ranges and corresponding copy sub-data in the copy data to make them consistent further comprises the following steps:

acquiring the sub-data in the first sub-data ranges from the current node, and acquiring the copy sub-data corresponding to the sub-data in the first sub-data ranges from other nodes where the copy data are located;

performing a pairwise comparison between the sub-data and the copy sub-data; and

repairing the inconsistent data based on a result of the comparison.

In this example implementation manner, when the sub-data in the first sub-data ranges are being repaired, the sub-data in the first sub-data ranges and corresponding copy sub-data on other nodes are read into a storage area, and then a pairwise comparison is performed, for example, when the sub-data 1 have two copy sub-data, namely 2 and 3, the process of the pairwise comparison and repair comprises:

1. comparing the sub-data 1 and the copy sub-data 2 to fill the inconsistent data, for example, if the record corresponding to the key currently read from the sub-data 1 is {1, 2, 3}, and the record corresponding to the key read from the copy sub-data 2 is {1, 2}, then the key {3} can be recorded as the missing data of the copy sub-data 2;

2. comparing the copy sub-data 2 and the copy sub-data 3 to fill the inconsistent data, for example, if the record corresponding to the key currently read from the copy sub-data 2 is {1, 2}, and the record corresponding to the key read from the copy sub-data 3 is {1}, then the key {2} can be recorded as the missing data of the copy sub-data 3;

3. comparing the sub-data 1 and the copy sub-data 3 to fill the inconsistent data, for example, if the record corresponding to the key currently read from the sub-data 1 is {1, 2, 3}, and the record corresponding to the key read from the copy sub-data 3 is {1}, then the key {2, 3} can be recorded as the missing data of the copy sub-data 3; and

finally, it can be determined that the key record in the copy sub-data 2 lacks {3}, and the key record in the copy sub-data 3 lacks {2, 3}, so the key record of {3} can be pushed to the node where the copy sub-data 2 are located to cause the node to repair the key record in the copy sub-data 2 to be {1, 2, 3}, and the key record of {2, 3} can be pushed to the node where the copy sub-data 3 are located to cause the node to repair the key record in the copy sub-data 3 to be {1, 2, 3}.

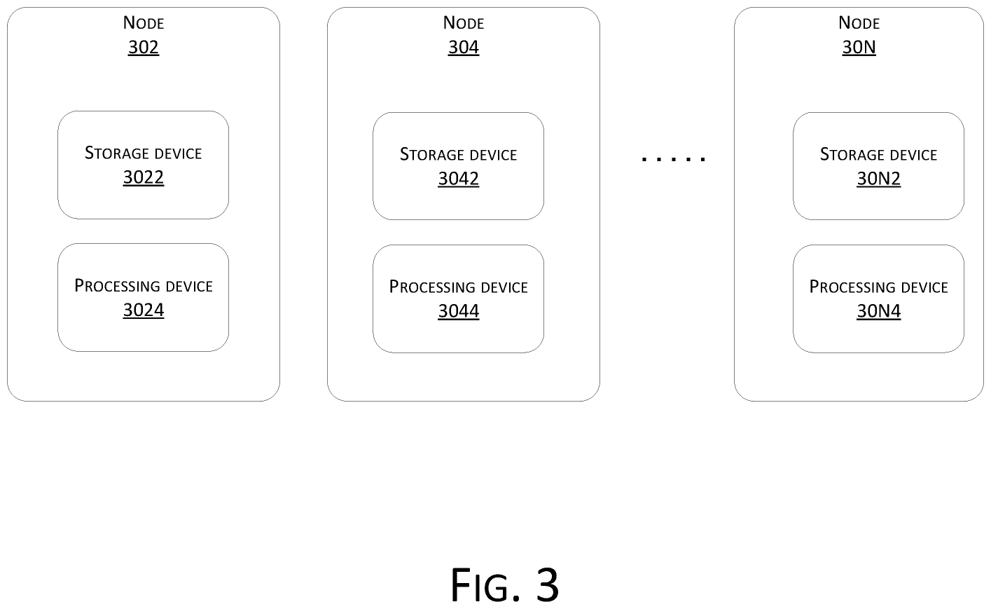

FIG. 3 is a structural block diagram of a data storage system according to an implementation manner of the present disclosure. As shown in FIG. 3, the data storage system comprises: multiple nodes 302, 304, . . . , 30N. each of which comprise one or more storage devices and processing devices, wherein n may be any integer. In the example of FIG. 3, the node 302 includes the storage device 3022 and the processing device 3024, the node 304 includes the storage device 3042 and the processing device 3044, the node 30N includes the storage device 30N2 and the processing device 30N4.

The storage devices 3022, 3042, . . . , 30N2 are configured to store master data and/or copy data, and the master data and the copy data corresponding to the same data are stored on storage devices of different nodes.

The processing devices 3024, 3044, . . . , 30N4 are configured to repair data on the storage devices and during the data repair process, the processing devices 3024-30N4 segment a master data range where the master data on the storage devices 3022-30N2 is located into multiple first sub-data ranges, and perform the data repair on each of the first sub-data ranges respectively, so as to repair inconsistent data between sub-data in the first sub-data ranges and corresponding copy sub-data in the copy data to make them consistent.

In this embodiment, the data storage system may be a distributed system, the multiple nodes 302-30N may form a cluster, and each of the nodes 302-30N comprises at least the storage device and the processing device. Each of the nodes 302-30N may poll and repair the master data stored on the storage device and the copy data stored on other nodes corresponding to the master data. After completing one round of repair, each of the nodes automatically starts a next round of repair, and through continuous polling, the master data and the copy data in the data storage system can always be kept consistent.

The processing device is configured to execute the repair process of the master data stored on the storage device of the node. The repair details can be found in the descriptions of FIG. 1 and related embodiments above, which are not elaborated herein.

In the data storage system of this embodiment, each of the nodes automatically polls and repairs data in a master data range stored thereon and, after segmenting the master data range into first sub-data ranges with finer granularity, performs data repair on the first sub-data ranges. In this way, it not only overcomes the defect of resource waste caused by performing repeated repair on data with multiple copies stored on multiple nodes during the data repair process in a storage system in the conventional techniques, but also can realize breakpoint resume by segmenting the master data range into first sub-data ranges with finer granularity and enable data repair on a node to be controlled in a long time frame by controlling the execution progress of a single repair, avoiding an instantaneous increase in resource consumption.

In an example implementation manner of this embodiment, when performing the data repair on each of the first sub-data ranges, the processing device generates first data repair tasks corresponding to each of the first sub-data ranges;

the processing device also assigns priorities to the first data repair tasks and then submits them to a task queue; and

the processing device further executes the first data repair tasks from the task queue according to the priority, so that the repair tasks repair the inconsistent data between the sub-data in the first sub-data ranges and the corresponding copy sub-data in the copy data to make them consistent.

In this example implementation manner, the processing device starts a first data repair task corresponding to each of the first sub-data ranges, and assigns a priority to the first data repair task and then submits it to the task queue; and the processing device also invokes and executes each of the first data repair tasks from the task queue according to the priority by starting a task scheduling process. For the details, reference may be made to the description of the data processing method above, which will not be elaborated herein.

In an example implementation manner of this embodiment, the processing device assigns a repair identifier to repaired data in the first sub-data ranges, and identifies the first sub-data ranges as being in a repair-completed state after all data in the first sub-data ranges are assigned the repair identifier.

In an example implementation manner of this embodiment, during the data repair process, the processing device determines a second sub-data range based on a first piece of data that starts to fail in the repair to a first piece of data that starts to succeed in the repair, generates a second data repair task corresponding to the second sub-data range, and assigns a priority to the second data repair task and then submits it to the task queue.

In an example implementation manner of this embodiment, after the node where the processing device is located is recovered from a downtime, the processing device regenerates the first data repair tasks for the first sub-data ranges in a repair-uncompleted state and submits the regenerated first data repair tasks to the task queue.

In an example implementation manner of this embodiment, when starting to perform the data repair on the first sub-data ranges, the processing device determines whether the current first sub-data ranges belong to the master data range on a current node and when the current first sub-data ranges belong to the master data range on the current node, performs the data repair on the current first sub-data ranges.

In an example implementation manner of this embodiment, after all the first sub-data ranges on the storage device are in the repair-completed state, the processing device starts a next round of the data repair process.

In an example implementation manner of this embodiment, after each round of the data repair process starts, the processing device determines a repair period according to a data size of the master data range and a preset expiration time of deleted data, and also determines a data repair speed according to the repair period; and the processing device completes a round of repair of all data in the master data range according to the data repair speed within the preset expiration time.

In an example implementation manner of this embodiment, the processing device acquires the sub-data in the first sub-data ranges from the storage device and acquires the copy sub-data corresponding to the sub-data in the first sub-data ranges from nodes where the copy data are located; and

the processing device performs a pairwise comparison between the sub-data and the copy sub-data and repairs the inconsistent data based on a result of the comparison.

For the details of the above-described example implementation manner, reference may be made to the corresponding description of the above-described data processing method, which will not be elaborated herein.

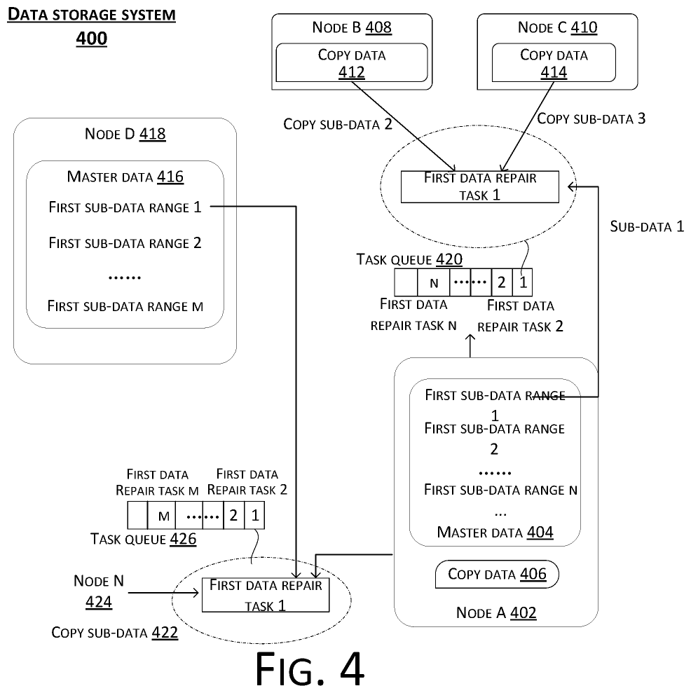

FIG. 4 is a schematic diagram of a data consistency repair architecture in a data storage system according to an implementation manner of the present disclosure. As shown in FIG. 4, the data storage system 400 comprises multiple nodes, wherein each of the nodes stores data in a distributed system, and the data may be master data or copy data. It is assumed that a node A 402 stores master data 404 and copy data 406, no correspondence exists between the master data 404 and the copy data 406. The copy data corresponding to the master data 404 are stored on nodes B 408 and C 410, and the nodes B 408 and C 410 respectively store copy data 412 and copy data 414 corresponding to the master data 404. Master data 416 corresponding to the copy data 406 are stored on another node other than the node A, for example, stored on a node D 418. It can be understood that in addition to the above-mentioned master data 404, copy data 406, master data 416, copy data 412, and copy data 414, other data, either master data or copy data, can also be stored on the nodes A 402, B 408, C 410, and D 418. It is only intended to illustrate the data repair process of the embodiment of the present disclosure, and the actual situation is not limited thereto.

After the node A 402 starts a round of the data repair process, it segments the master data range where the master data 404 are located into multiple first sub-data ranges 1-n, where n may be any integer, and starts n first data repair tasks 1-n for the multiple first sub-data ranges 1-n to respectively repair the sub-data in the multiple first sub-data ranges 1-n. First, the n first data repair tasks 1-n are assigned priorities. For example, the first data repair tasks 1-n are assigned the priorities in a descending order according to the sub-data storage addresses in an ascending order. That is, the first data repair tasks corresponding to the sub-data stored at the front have a higher priority than the first data repair tasks corresponding to the sub-data stored at the rear. Therefore, it can be obtained that the priority order is that the first data repair task 1> the first data repair task 2> . . . > the first data repair task n. After the above-mentioned first data repair tasks 1-n are submitted to the task queue 420, the execution engine may execute the first data repair tasks 1-n in a descending order of priority. Taking the execution process of the first data repair task 1 as an example, the sub-data 1 in the first sub-data range 1 corresponding to the first data repair task 1 are acquired from the node A 402, and the copy sub-data 2 in the copy data 412 and the copy sub-data 3 in the copy data 414 corresponding to the sub-data 1 are acquired from the nodes B 408 and C 410 respectively. Then, a pairwise comparison is performed on the sub-data 1, the copy sub-data 2, and the copy sub-data 3. If the sub-data 1 and the copy sub-data 2 are inconsistent, and the data in the sub-data 1 are less than those in the copy sub-data 2, the data in the copy sub-data 2 is used to repair the sub-data 1, that is, to fill the missing data in the sub-data 1. If the copy sub-data 3 and the sub-data 1 are inconsistent, and the data in the copy sub-data 3 are less than those in the sub-data 1, the missing data in the copy sub-data 3 is sent to the node C 410 to request the node C 410 to fill the missing data in the copy sub-data 3. After the first data repair task 1 is completed, and the corresponding sub-data are all successfully repaired, the state of the first sub-data range 1 corresponding to the first data repair task 1 is identified as being in the repair-completed state. In the above-described manner, all the first data repair tasks 1-n in the task queue are completed in sequence.

After all the first sub-data ranges 1-n corresponding to the master data 404 on the node A 402 are identified as being in the repair-completed state, it can be considered that the master data 404 are successfully repaired, and next master data (if any) can be successively repaired. If all the master data on the node A are repaired, the node A can start a next round of the data repair process, and repeat the above-described steps.

After the node D 418 starts a round of the data repair process, the master data 416 is repaired through the same process as above. Assuming that the first sub-data ranges 1−m for the master data 416, where m may be any integer, are obtained after segmentation, first data repair tasks 1-m are started correspondingly. The copy data 406 on the node A 402, and other copy sub-data 422 from other copy data of the master data 416 on the node N 424, where n may be any integer, are also repaired in the repair process according to the task queue 426.

The foregoing description is for illustration only, and the data repair in the distributed system 400 is not limited to the content listed in the above-described process. All nodes can perform data repair in the above-described manner, and each of the master data on each node can be repaired by using the above-described process.

The apparatus embodiments of the present disclosure are described below, which can be used to execute the method embodiments of the present disclosure.

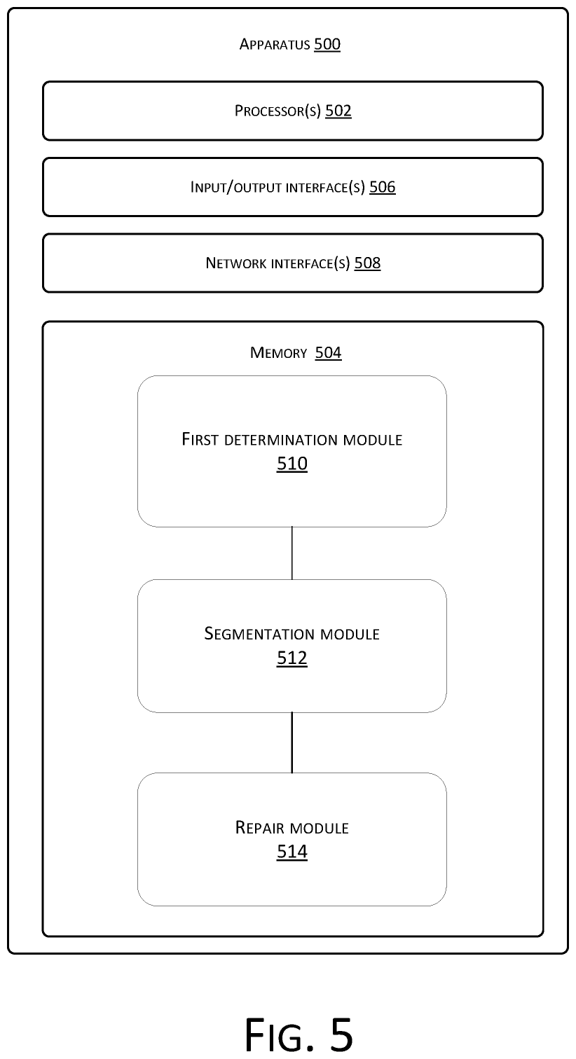

FIG. 5 is a structural block diagram of a data processing apparatus according to an implementation manner of the present disclosure. As shown in FIG. 5, the apparatus can be implemented through software, hardware, or a combination thereof to become a part or all of an electronic device.

As shown in FIG. 5, the apparatus 500 includes one or more processor(s) 502 or data processing unit(s) and memory 504. The apparatus 500 may further include one or more input/output interface(s) 506 and one or more network interface(s) 508. The memory 504 is an example of computer-readable media.

Computer-readable media further include non-volatile and volatile, removable and non-removable media employing any method or technique to achieve information storage. The information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic storage devices, or any other non-transmission medium, which may be used to store information that can be accessed by a computing device. As defined herein, the computer-readable media do not include transitory media, such as modulated data signals and carriers.

The memory 504 may store therein a plurality of modules or units including:

a first determination module 510, configured to determine a master data range on a current node, wherein master data in the master data range corresponds to multiple copy data stored on other nodes;

a segmentation module 512, configured to segment the master data range into multiple first sub-data ranges; and

a repair module 514, configured to perform data repair on each of the first sub-data ranges respectively, so as to repair inconsistent data between sub-data in the first sub-data ranges and corresponding copy sub-data in the copy data to make them consistent.

In this embodiment, a data cluster comprises multiple nodes, each of the nodes stores data in a distributed system, and the same block of data in the distributed system may include multiple copies, which are respectively stored on the multiple nodes, for example, on 3 nodes, and one of the nodes stores master data of the block of data, and the other nodes store copy data of the block of data. In order to ensure that the data in the distributed system are not lost, it is necessary to ensure consistency between the master data and the copy data. In order to ensure consistency between the master data and the copy data, in this embodiment of the present disclosure, each of the nodes automatically repairs the master data it is responsible for (if the node also stores copy data of other nodes, the copy data will be repaired by the other nodes rather than the node). It should be noted that multiple different blocks of data can be stored on the same node, and the multiple different blocks of data can be master data or copy data, that is to say, both master data and copy data can be stored on the same node.

Therefore, in the data repair process according to this embodiment of the present disclosure, each of the nodes repairs the master data stored on the node, and the copy data stored on the node are repaired by the node storing the master data corresponding to the copy data. In this way, it can avoid the problem that multiple nodes repeatedly repair the same block of data, thereby saving system resources.

In this embodiment, after a round of repair starts, each of the nodes determines the master data range stored on the current node, that is, the range of the master data stored on the current node, for example, the range from the first record to the last record of the master data. Of course, it can be understood that when the master data of multiple blocks of data are stored on the current node, there may be multiple master data ranges. It should be noted that the master data in the master data range has multiple copy data stored on other nodes. The purpose of data repair is to repair the master data in the master data range and the multiple copy data stored on other nodes, so as to keep consistency between the master data and the copy data.

After the current node determines the master data range, the master data range can be segmented into multiple first sub-data ranges, and the size of the sub-data in the first sub-data ranges can be predefined, for example, the size of the sub-data in the first sub-data ranges is 200M by default. Of course, it can be modified to other sizes in advance if necessary, depending on the actual situation, which is not limited herein. For example, in the segmentation process, the segmentation may start from the smallest data record in the master data range, and every N pieces of data are segmented into a first sub-data range. When there are multiple blocks of master data on the current node, the above-described method is used for segmenting each block of master data.

After multiple first sub-data ranges are obtained by segmentation, data repair may be performed on each of the first sub-data ranges. During the repair process of the first sub-data ranges, for example, starting from the first one of the first sub-data ranges, the data in the current first sub-data range in the master data and the data corresponding to the current sub-data range in the copy data stored on other nodes are read and compared. If they are inconsistent, it can be determined whether the data in the current first sub-data range in the master data are incorrect or the data in the current first sub-data range in the copy data are incorrect. For example, if the current node stores the master data and the other two nodes store the copy data respectively, three pieces of data in the current first sub-data range can be read from the current node and the other two nodes, and by a pairwise comparison of consistency, it can be determined which node has wrong data and repair the wrong data. In some embodiments, during the comparison of data consistency, one key record may be used as the granularity for comparison, and this repair method will not cause a situation in which batches of data are mis-repaired when only individual keys are different.

After the data in all the first sub-data ranges on the current node are repaired, the current node can start a next round of polling and repair and repeat the above-described repair process. In this embodiment of the present disclosure, when a round of repair starts, the time required for the round of repair can be calculated through flow control and according to the data size in the master data range on the current node, and the flow control speed can be controlled to ensure that the round of repair is completed in a preset time frame. The preset time frame is related to a storage policy of a distributed file system. For example, when Cassandra deletes a piece of data, it will perform an insert operation. The newly inserted piece of data is called a tombstone. The biggest difference between a tombstone and a normal record is that the tombstone has an expiration time. When the expiration time is reached, the tombstone data will be actually deleted from the disk when Cassandra performs a compaction operation; therefore, in this embodiment of the present disclosure, when Cassandra is used for storing data, the preset time frame can be set to be the tombstone's expiration time (10 days by default).

During the repair process of a distributed system according to the embodiments of the present disclosure, each node automatically polls and repairs data in a master data range stored thereon and, after segmenting the master data range into first sub-data ranges with finer granularity, performs data repair on the first sub-data ranges. In this way, it not only overcomes the defect of resource waste caused by performing repeated repair on data with multiple copies stored on multiple nodes during the data repair process in the conventional techniques but also can realize breakpoint resume by segmenting the master data range into first sub-data ranges with finer granularity and enable data repair on a node to be controlled in a long time frame by controlling the execution progress of a single repair, avoiding an instantaneous increase in resource consumption.

In an example implementation manner of this embodiment, the repair module 514 comprises:

a first generation sub-module, configured to generate first data repair tasks corresponding to each of the first sub-data ranges, wherein the repair tasks are used for repairing the inconsistent data between the sub-data in the first sub-data ranges and the corresponding copy sub-data in the copy data to make them consistent; and

a submission sub-module, configured to assign priorities to the first data repair tasks and then submitting them to a task queue, so that the first data repair tasks are executed from the task queue according to the priorities.

In this example implementation manner, a first data repair task may be started for each of the first sub-data ranges, a priority may also be set for each of the first sub-data ranges according to a preset factor, and the first data repair tasks may be invoked and executed according to the set priority, for example, the first data repair task with a higher priority may be invoked and executed first. In some embodiments, the priority assigned to a first data repair task corresponding to a first sub-data range may indicate the urgency of data repair of the first sub-data range, and the first sub-data ranges requiring urgent repair may be assigned a higher priority, while those that do not require urgent repair may be assigned a lower priority. For example, a first sub-data range at the front of the master data range may be assigned a higher priority, while a first sub-data range at the rear may be assigned a lower priority. In this way, more urgent first sub-data ranges can be repaired before the other first sub-data ranges according to the degree of urgency.

In an example implementation manner of this embodiment, the apparatus further comprises:

an assigning module, configured to assign a repair identifier to repaired data in the first sub-data ranges; and

an identification module, configured to identify the first sub-data ranges as being in a repair-completed state after all data in the first sub-data ranges are assigned the repair identifier.

In this example implementation manner, the first data repair tasks may perform comparative repair at a fine granularity on the data in the first sub-data ranges, for example, when one key record is used as the granularity for comparative repair of the data, the repair can be performed by comparing whether the data record corresponding to the current key in the first sub-data ranges is consistent with the record corresponding to the key in the copy data. When the data corresponding to the current key are consistent with the corresponding data in the copy data, the data corresponding to the key can be assigned the repair identifier, indicating that the data have been repaired, and when the data corresponding to the current key are inconsistent with the corresponding data in the copy data, the inconsistent data between the current key and the copy data can be repaired, and after the repair is completed, the data corresponding to the current key are assigned the repair identifier. In this way, after all the data in the first sub-data ranges are assigned the repair identifier, it can be determined that the data in the first sub-data ranges have been repaired, so the first sub-data ranges can be identified as being in a repair-completed state, otherwise the data in the first sub-data ranges can be identified as being in a repair-uncompleted state.

In an example implementation manner of this embodiment, the apparatus further comprises:

a second determination module, configured to determine a second sub-data range based on a first piece of data that starts to fail in the repair to a first piece of data that starts to succeed in the repair;

a first generation module, configured to generate a second data repair task corresponding to the second sub-data range; and

a submission module, configured to assign a priority to the second data repair task and then submit it to the task queue.

In this example implementation manner, during the data repair process, if the node where the copy data are located goes down, the data will fail to be repaired starting from the downtime of the node where the copy data are located, and then repeated repair may be performed on each piece of data, such as 3 rounds of repair. If all the rounds of repair fail, the piece of data is recorded as failing in the repair and subsequent data are continued to be repaired; and after the node where the copy data are located is recovered, the subsequent data can be repaired successfully, so a second sub-data range can be determined from a first piece of data that starts to fail in the repair to a first piece of data that starts to succeed in the repair, and all the data in the second sub-data range fail to be repaired due to the downtime of the node where the copy data are located. Therefore, a second data repair task can be generated for the data in the second sub-data range, and the second data repair task can be assigned a priority and then submitted to the task queue, so that the second data repair task can be invoked from the task queue to re-repair the data in the second sub-data range. The second sub-data range is a sub-data range included in the first sub-data ranges. After the second data repair task corresponding to the second sub-data range is completed and all the data in the second sub-data range is successfully repaired, the first sub-data ranges are considered to be in a repair-completed state.

In an example implementation manner of this embodiment, the apparatus further comprises:

a second generation module, configured to, after the current node is recovered from a downtime, regenerate the first data repair tasks for the first sub-data ranges in a repair-uncompleted state, and submit the regenerated first data repair tasks to the task queue.

In this example implementation manner, after the current node storing the master data goes down and gets recovered, the first sub-data ranges currently in the repair-completed state and the first sub-data ranges currently in the repair-uncompleted state can be obtained by querying the information recorded by the system. For the first sub-data ranges currently in the repair-uncompleted state, corresponding first data repair tasks can be regenerated, and the regenerated first data repair tasks can be assigned a priority and then submitted to the task queue to continue the repair of the data in the first sub-data ranges. In this implementation manner, the function of breakpoint resume can be realized, and the granularity of breakpoint resume is one sub-data range. In some embodiments, the size of one sub-data range may be set as 200M, so the granularity of breakpoint resume in this way is relatively fine, and the data repair efficiency can be improved.

In an example implementation manner of this embodiment, the repair module 514 comprises:

a determination sub-module, configured to determine whether the current first sub-data range belongs to the master data range on the current node; and

a first repair sub-module, configured to, when the current first sub-data range belongs to the master data range on the current node, perform the data repair on the current first sub-data range.

In this example implementation manner, before repairing the data in each of the first sub-data ranges, it may be determined whether the current first sub-data range still belongs to the master data range on the current node. This is because, after a new node is added to the cluster, there may be a situation that the master data range to be repaired by a node in the original cluster overlaps with the master data range to be repaired by the new node, for example, the master data range that the node A is originally responsible for is 1-5, and the newly added node B shares the master data range of 3-5. Since the node A will still repair the master data range of 1-5 during this round of repair, while the node B will repair the master data range of 3-5 once it is added and its state is changed to normal, there may be a situation that the data range of 3-5 is subjected to overlapped repair. This will not affect the correctness, but will cause repeated data repair. In order to solve this problem, the embodiment of the present disclosure uses one first sub-data range as the granularity, and when starting a data repair process of a new first sub-data range in each round, it only needs to first determine whether the first sub-data range still belongs to the master data range of the current node. In this way, the problem of resource waste caused by repeated data repair after a new node is added is solved.

In an example implementation manner of this embodiment, the apparatus further comprises:

a starting module, configured to, after all the first sub-data ranges on the current node are in the repair-completed state, start a next round of the data repair process.

In this example implementation manner, the data repair process of each node may be an infinitely cyclic process, and a next round of the data repair process is started after one round of the data repair process ends. The element indicating the end of each round of the data repair process is that all the sub-data ranges in the master data range on the current node are in the repair-completed state. In this way, each node in the cluster can automatically poll and repair the master data in the master data range stored thereon and the copy data stored on other nodes corresponding to the master data in the master data range on other nodes, and eventually, all data on all nodes in the cluster can be continuously repaired so as to always keep consistency between the master data and the copy data in the cluster.

In an example implementation manner of this embodiment, the apparatus further comprises:

a third determination module, configured to, after each round of the data repair process starts, determine a repair period of the current node according to a data size of the master data range and a preset expiration time of deleted data; and

a fourth determination module, configured to determine a data repair speed according to the repair period, so as to complete a round of repair of all data in the master data range according to the data repair speed within the preset expiration time.

In this example implementation manner, the preset expiration time of deleted data is the time that the deleted data are retained in a distributed system, which may vary with an adopted distributed system, for example, the preset expiration time in the Cassandra system may be gc_grace_seconds. When the Cassandra system deletes a piece of data, it will perform an insert operation. The newly inserted piece of data is called a tombstone. The biggest difference between a tombstone and a normal record is that the tombstone has an expiration time gc_grace_seconds. When the expiration time is reached, the tombstone data will be completely deleted. Therefore, the time that the data deleted at the application level are retained before they are completely deleted by the system is the preset expiration time of the deleted data. If a round of data repair is completed before the preset expiration time is reached, it will not eventually cause inconsistency between the master data and the copy data.

In this embodiment of the present disclosure, a data repair speed is determined according to the data size in the master data range and the preset expiration time, so that the data in the master data range on the current node are repaired according to the data repair speed to control the time for completing a round of repair process within the preset expiration time. In this way, the embodiment of the present disclosure balances a huge amount of repair tasks (for example, comparison of hash calculations, filling of data gaps between the master data and the copy data, etc.), and performs repair in the allowable time frame of the distributed system, reducing the impact of data repair on customers.

In an example implementation manner of this embodiment, the repair module 514 comprises:

an acquisition sub-module, configured to acquire the sub-data in the first sub-data ranges from the current node, and acquire the copy sub-data corresponding to the sub-data in the first sub-data ranges from other nodes where the copy data are located;

a comparison sub-module, configured to perform a pairwise comparison between the sub-data and the copy sub-data; and

a second repair sub-module, configured to repair the inconsistent data based on a result of the comparison.

In this example implementation manner, when the sub-data in the first sub-data ranges are being repaired, the sub-data in the first sub-data ranges and corresponding copy sub-data on other nodes are read into a storage area, and then a pairwise comparison is performed, for example, when the sub-data 1 have two copy sub-data, namely 2 and 3, the process of the pairwise comparison and repair comprises:

1. comparing the sub-data 1 and the copy sub-data 2 to fill the inconsistent data, for example, if the record corresponding to the key currently read from the sub-data 1 is {1, 2, 3}, and the record corresponding to the key read from the copy sub-data 2 is {1, 2}, then the key {3} can be recorded as the missing data of the copy sub-data 2;

2. comparing the copy sub-data 2 and the copy sub-data 3 to fill the inconsistent data, for example, if the record corresponding to the key currently read from the copy sub-data 2 is {1, 2}, and the record corresponding to the key read from the copy sub-data 3 is {1}, then the key {2} can be recorded as the missing data of the copy sub-data 3;

3. comparing the sub-data 1 and the copy sub-data 3 to fill the inconsistent data, for example, if the record corresponding to the key currently read from the sub-data 1 is {1, 2, 3}, and the record corresponding to the key read from the copy sub-data 3 is {1}, then the key {2, 3} can be recorded as the missing data of the copy sub-data 3; and

finally, it can be determined that the key record in the copy sub-data 2 lacks {3}, and the key record in the copy sub-data 3 lacks {2, 3}, so the key record of {3} can be pushed to the node where the copy sub-data 2 are located to cause the node to repair the key record in the copy sub-data 2 to be {1, 2, 3}, and the key record of {2, 3} can be pushed to the node where the copy sub-data 3 are located to cause the node to repair the key record in the copy sub-data 3 to be {1, 2, 3}.

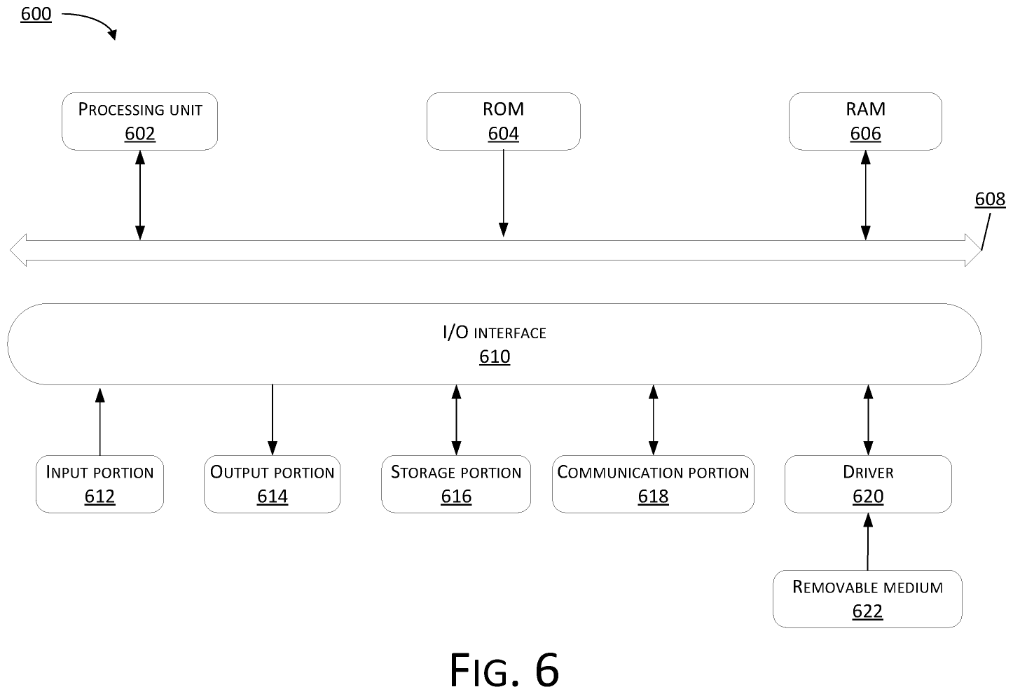

FIG. 6 is a schematic structural diagram of an electronic device suitable for implementing a data processing method according to an implementation manner of the present disclosure.

As shown in FIG. 6, an electronic device 600 comprises a processing unit 602, which may be implemented as a processing unit such as a CPU, a GPU, an FPGA, and an NPU. The processing unit 602 can perform various processes in the implementation manners of any one of the above-described methods of the present disclosure according to a program stored in a read-only memory (ROM) 604 or a program loaded from a storage portion 616 into a random-access memory (RAM) 606. In the RAM 606, various programs and data necessary for the operation of the electronic device 600 are also stored. The processing unit 602, the ROM 604, and the RAM 606 are connected to each other through a bus 608. An input/output (I/O) interface 610 is also connected to the bus 608.

The following components are connected to the I/O interface 610: an input portion 612 comprising a keyboard, a mouse, etc.; an output portion 614 comprising a cathode ray tube (CRT), a liquid crystal display (LCD), and a speaker, etc.; a storage portion 616 comprising a hard disk, etc.; and a communication portion 618 comprising a network interface card such as a LAN card, a modem, and the like. The communication portion 618 performs communication processing via a network such as the Internet. A driver 620 is also connected to the I/O interface 610 as needed. A removable medium 622, such as a magnetic disk, an optical disk, a magneto-optical disk, and a semiconductor memory, is installed on the drive 620 as needed so that a computer program read therefrom can be installed into the storage portion 616 as needed.

In particular, according to an implementation manner of the present disclosure, any one of the methods in the above-referenced implementation manners of the present disclosure may be implemented as a computer software program. For example, an implementation manner of the present disclosure comprises a computer program product having a computer program tangibly embodied on a readable medium thereof, and the computer program comprises program codes for performing any one of the methods in the implementation manners of the present disclosure. In such an implementation manner, the computer program may be downloaded and installed from the network via the communication portion 618 and/or installed from the removable medium 622.

The flowchart and block diagrams in the accompanying drawings illustrate the architectures, functions, and operations of possible implementations of systems, methods, and computer program products in various implementation manners of the present disclosure. In this regard, each block in the flowchart or block diagrams may represent a module, program segment, or code portion that includes one or more executable instructions for implementing the specified logical functions. It should also be noted that, in some alternative implementations, the functions noted in the blocks may occur in an order different from that noted in the accompanying drawings. For example, two blocks shown in succession may, in fact, be executed substantially concurrently, or the blocks may sometimes be executed in the reverse order, depending on the functionality involved. It should also be noted that each block in the block diagrams and/or flowchart and combinations of the blocks in the block diagrams and/or flowchart can be implemented in dedicated hardware-based systems for performing the specified functions or operations, or can be implemented in a combination of dedicated hardware and computer instructions.

The units or modules involved in the implementation manners of the present disclosure can be implemented in software or hardware. The described units or modules may also be provided in a processor, and the names of these units or modules do not constitute a limitation to the units or modules themselves in certain circumstances.

In another aspect, the present disclosure also provides a computer-readable storage medium, which may be a computer-readable storage medium included in the apparatus described in the foregoing implementation manners, or a standalone computer-readable storage medium that is unassembled into a device. The computer-readable storage medium stores one or more programs used by one or more processors to perform the method described in the present disclosure.

The above description merely illustrates the example embodiments of the present disclosure and the technical principles employed. It should be understood by those skilled in the art that the scope of the invention involved in the present disclosure is not limited to the technical solutions formed by the specific combination of the above-described technical features, and should also cover other technical solutions formed by any combination of the above-described technical features or their equivalent features without departing from the inventive concept, for example, a technical solution formed by replacing the above-described features with (but not limited to) the technical features with similar functions disclosed in the present disclosure.

The present disclosure may further be understood with clauses as follows.

Clause 1. A data processing method, comprising:

determining a master data range on a current node, wherein master data in the master data range corresponds to multiple copy data stored on other nodes;

segmenting the master data range into multiple first sub-data ranges; and

performing data repair on each of the first sub-data ranges respectively, so as to repair inconsistent data between sub-data in the first sub-data ranges and corresponding copy sub-data in the copy data to make them consistent.

Clause 2. The method according to clause 1, wherein the performing data repair on each of the first sub-data ranges respectively, so as to repair inconsistent data between sub-data in the first sub-data ranges and corresponding copy sub-data in the copy data to make them consistent comprises:

generating a first data repair task corresponding to each of the first sub-data ranges, wherein the repair task is used for repairing the inconsistent data between the sub-data in the first sub-data ranges and the corresponding copy sub-data in the copy data to make them consistent; and

assigning priorities to the first data repair tasks and then submitting them to a task queue, so that the first data repair tasks are executed from the task queue according to the priorities.

Clause 3. The method according to clause 1 or 2, further comprising:

assigning a repair identifier to repaired data in the first sub-data range; and

identifying the first sub-data range as being in a repair-completed state after all data in the first sub-data range are assigned the repair identifier.

Clause 4. The method according to clause 3, further comprising:

determining a second sub-data range based on a first piece of data that starts to fail in the repair to a first piece of data that starts to succeed in the repair;

generating a second data repair task corresponding to the second sub-data range; and

assigning a priority to the second data repair task and then submitting it to the task queue.

Clause 5. The method according to any one of clauses 1-2 and 4, further comprising:

after the current node is recovered from a downtime, regenerating the first data repair tasks for the first sub-data ranges in a repair-uncompleted state, and submitting the regenerated first data repair tasks to the task queue.

Clause 6. The method according to any one of clauses 1-2 and 4, wherein the performing data repair on each of the first sub-data ranges respectively, so as to repair inconsistent data between sub-data in the first sub-data ranges and corresponding copy sub-data in the copy data to make them consistent comprises:

determining whether the current first sub-data range belongs to the master data range on the current node; and

when the current first sub-data range belongs to the master data range on the current node, performing the data repair on the current first sub-data range.

Clause 7. The method according to any one of clauses 1-2 and 4, further comprising:

after all the first sub-data ranges on the current node are in the repair-completed state, starting a next round of the data repair process.

Clause 8. The method according to any one of clauses 1-2 and 4, further comprising:

after each round of the data repair process starts, determining a repair period of the current node according to a data size of the master data range and a preset expiration time of deleted data; and

determining a data repair speed according to the repair period, so as to complete a round of repair of all data in the master data range according to the data repair speed within the preset expiration time.

Clause 9. The method according to any one of clauses 1-2 and 4, wherein the performing data repair on each of the first sub-data ranges respectively, so as to repair inconsistent data between sub-data in the first sub-data ranges and corresponding copy sub-data in the copy data to make them consistent comprises:

acquiring the sub-data in the first sub-data ranges from the current node, and acquiring the copy sub-data corresponding to the sub-data in the first sub-data ranges from other nodes where the copy data are located;

performing a pairwise comparison between the sub-data and the copy sub-data; and

repairing the inconsistent data based on a result of the comparison.

Clause 10. A data storage system, comprising: multiple nodes which comprise a storage device and a processing device, wherein

the storage device is configured to store master data and/or copy data, and the master data and the copy data corresponding to the same data are stored on the storage devices of different nodes; and

the processing device is configured to repair data on the storage device and during the data repair process, the processing device segments a master data range where the master data on the storage device is located into multiple first sub-data ranges, and performs the data repair on each of the first sub-data ranges respectively, so as to repair inconsistent data between sub-data in the first sub-data ranges and corresponding copy sub-data in the copy data to make them consistent.

Clause 11. The system according to clause 10, wherein when performing the data repair on each of the first sub-data ranges, the processing device generates first data repair tasks corresponding to each of the first sub-data ranges;

the processing device also assigns priorities to the first data repair tasks and then submits them to a task queue; and

the processing device further executes the first data repair tasks from the task queue according to the priority, so that the repair tasks repair the inconsistent data between the sub-data in the first sub-data ranges and the corresponding copy sub-data in the copy data to make them consistent.

Clause 12. The system according to clause 10 or 11, wherein the processing device assigns a repair identifier to repaired data in the first sub-data ranges and identifies the first sub-data ranges as being in a repair-completed state after all data in the first sub-data ranges are assigned the repair identifier.

Clause 13. The system according to clause 12, wherein during the data repair process, the processing device further determines a second sub-data range based on a first piece of data that starts to fail in the repair to a first piece of data that starts to succeed in the repair, generates a second data repair task corresponding to the second sub-data range, and assigns a priority to the second data repair task and then submits it to the task queue.

Clause 14. The system according to any one of clauses 10-11 and 13, wherein after the node where the processing device is located is recovered from a downtime, the processing device regenerates the first data repair tasks for the first sub-data ranges in a repair-uncompleted state and submits the regenerated first data repair tasks to the task queue.

Clause 15. The system according to any one of clauses 10-11 and 13, wherein when starting to perform the data repair on the first sub-data ranges, the processing device determines whether the current first sub-data range belongs to the master data range on a current node and, when the current first sub-data range belongs to the master data range on the current node, performs the data repair on the current first sub-data range.

Clause 16. The system according to any one of clauses 10-11 and 13, wherein after all the first sub-data ranges on the storage device are in the repair-completed state, the processing device starts a next round of the data repair process.

Clause 17. The system according to any one of clauses 10-11 and 13, wherein after each round of the data repair process starts, the processing device determines a repair period according to a data size of the master data range and a preset expiration time of deleted data, and also determines a data repair speed according to the repair period; and the processing device completes a round of repair of all data in the master data range according to the data repair speed within the preset expiration time.

Clause 18. The system according to any one of clauses 10-11 and 13, wherein the processing device acquires the sub-data in the first sub-data ranges from the storage device and acquires the copy sub-data corresponding to the sub-data in the first sub-data ranges from nodes where the copy data are located; and the processing device performs a pairwise comparison between the sub-data and the copy sub-data and repairs the inconsistent data based on a result of the comparison.

Clause 19. A data processing apparatus, comprising:

a first determination module, configured to determine a master data range on a current node, wherein master data in the master data range corresponds to multiple copy data stored on other nodes;

a segmentation module, configured to segment the master data range into multiple first sub-data ranges; and

a repair module, configured to perform data repair on each of the first sub-data ranges respectively, so as to repair inconsistent data between sub-data in the first sub-data ranges and corresponding copy sub-data in the copy data to make them consistent.

Clause 20. An electronic device, comprising: a memory and a processor, wherein

the memory is configured to store one or more computer instructions, and the one or more computer instructions are executed by the processor to implement the method according to any one of clauses 1-9.

Clause 21. A computer-readable storage medium having computer instructions stored thereon, wherein the computer instructions, when executed by a processor, implement the method according to any one of clauses 1-9.

What is claimed is:

1. A method comprising:
determining a master data range on a current node, wherein master data in the master data range corresponds to multiple copy data stored on other nodes;
segmenting the master data range into multiple first sub-data ranges; and
performing a data repair on a respective first sub-data range of the multiple first sub-data ranges to repair inconsistent data between sub-data in the respective first sub-data range and corresponding copy sub-data in the multiple copy data to make them consistent.

2. The method according to claim 1, wherein the performing the data repair on the respective first sub-data range of the multiple first sub-data ranges to repair inconsistent data between the sub-data in the respective first sub-data range and corresponding copy sub-data in the multiple copy data to make them consistent comprises:
generating a first data repair task corresponding to the respective first sub-data range, wherein the first repair task is used for repairing the inconsistent data between the sub-data in the first sub-data ranges and the corresponding copy sub-data in the copy data to make them consistent;
assigning priorities to first data repair tasks respectively; and
submitting the first data repair tasks to a task queue, so that the first data repair tasks are executed from the task queue according to the priorities.

3. The method according to claim 2, further comprising:
after the current node is recovered from a downtime, regenerating the first data repair task for the respective first sub-data range that is in a repair-uncompleted state; and
submitting the regenerated first data repair tasks to the task queue.

4. The method according to claim 1, further comprising:
assigning a repair identifier to repaired data in the respective first sub-data range; and
identifying the respective first sub-data range as being in a repair-completed state after all data in the respective first sub-data range are assigned the repair identifier.

5. The method according to claim 3, further comprising:
determining a second sub-data range based on a first piece of data that starts to fail in the data repair to a first piece of data that starts to succeed in the data repair;
generating a second data repair task corresponding to the second sub-data range;
assigning a priority to the second data repair task; and
submitting the second data repair task to the task queue.

6. The method according to claim 1, wherein the performing the data repair on the respective first sub-data range of the multiple first sub-data ranges to repair inconsistent data between the sub-data in the respective first sub-data range and corresponding copy sub-data in the multiple copy data to make them consistent comprises:
determining whether a current first sub-data range belongs to the master data range on the current node; and
in response to determining that the current first sub-data range belongs to the master data range on the current node, performing the data repair on the current first sub-data range.

7. The method according to claim 1, further comprising:
after all of the first sub-data ranges on the current node are in a repair-completed state, starting a next round of the data repair.

8. The method according to claim 1, further comprising:
after each round of the data repair starts, determining a repair period of the current node according to a data size of the master data range and a preset expiration time of deleted data; and
determining a data repair speed according to the repair period to complete a round of repair of all data in the master data range according to the data repair speed within the preset expiration time.

9. The method according to claim 1, wherein the performing the data repair on the respective first sub-data range of the multiple first sub-data ranges to repair inconsistent data between the sub-data in the respective first sub-data range and corresponding copy sub-data in the multiple copy data to make them consistent comprises:
acquiring sub-data in the respective first sub-data range from the current node;
acquiring copy sub-data corresponding to the sub-data in the respective first sub-data range from other nodes where the multiple copy data are located;
performing a comparison between the sub-data and the copy sub-data; and
repairing the inconsistent data based on a result of the comparison.

10. A data storage system, the system comprising:
multiple nodes, a respective node of the multiple nodes including a storage device and a processing device, wherein:
the storage device stores master data and/or copy data, and the master data and the copy data corresponding to same data are stored on storage devices of different nodes in the multiple nodes; and
the processing device repairs data on the storage device and during a data repair process, segments a master data range of the master data located on the storage device into multiple first sub-data ranges, and performs a data repair on a respective first sub-data range of the multiple first sub-data ranges to repair inconsistent data between sub-data in the respective first sub-data range and corresponding copy sub-data in the multiple copy data to make them consistent.

11. The system according to claim 10, wherein:
the processing device assigns priorities to first data repair tasks corresponding to the first sub-data ranges and then submits the first data repair tasks to a task queue; and
the processing device further executes the first data repair tasks from the task queue according to the priorities to repair the inconsistent data between the sub-data in the first sub-data ranges and the corresponding copy sub-data in the copy data to make them consistent.

12. The system according to claim 11, wherein the processing device assigns a repair identifier to repaired data in the respective first sub-data range, and identifies the respective first sub-data range as being in a repair-completed state after all data in the respective first sub-data range are assigned the repair identifier.

13. The system according to claim 12, wherein during the data repair process, the processing device further:
determines a second sub-data range based on a first piece of data that starts to fail in the data repair to a first piece of data that starts to succeed in the data repair;
generates a second data repair task corresponding to the second sub-data range;
assigns a priority to the second data repair task; and
submits the second data repair task to the task queue.

14. The system according to claim 10, wherein after a current node is recovered from a downtime, the processing device regenerates a respective first data repair task for the respective first sub-data range that is in a repair-uncompleted state, and submits the regenerated first data repair tasks to a task queue.

15. The system according to claim 10, wherein when starting to perform the data repair on the first sub-data ranges, the processing device determines whether a current first sub-data range belongs to the master data range on a current node, and in response to determining that the current first sub-data range belongs to the master data range on the current node, performs the data repair on the current first sub-data range.

16. The system according to claim 10, wherein after all the first sub-data ranges on the storage device are in a repair-completed state, the processing device starts a next round of the data repair.

17. The system according to claim 10, wherein after each round of the data repair process starts, the processing device determines a repair period of a current node according to a data size of the master data range and a preset expiration time of deleted data, and determines a data repair speed according to the repair period to complete a round of repair of all data in the master data range according to the data repair speed within the preset expiration time.

18. The system according to claim 10, wherein the processing device further:
acquires sub-data in the respective first sub-data range from a current node;
acquires copy sub-data corresponding to the sub-data in the respective first sub-data range from other nodes where the multiple copy data are located;
performs a comparison between the sub-data and the copy sub-data; and
repairs the inconsistent data based on a result of the comparison.

19. The system according to claim 18, wherein the comparison is a pairwise comparison.

20. One or more memories storing thereon computer-readable instructions that, when executed by one or more processors, cause the one or more processors to perform acts comprising:
determining a master data range on a current node, wherein master data in the master data range corresponds to multiple copy data stored on other nodes;
segmenting the master data range into multiple first sub-data ranges; and
performing a data repair on a respective first sub-data range of the multiple first sub-data ranges to repair inconsistent data between sub-data in the respective first sub-data range and corresponding copy sub-data in the multiple copy data to make them consistent.
